(19) United States
(12) Patent Application Publication
(10) Pub. No.: US 2023/0180098 A1
(43) Pub. Date: Jun. 8, 2023

(54) NR Sidelink Relaying

(71) Applicant: Fraunhofer-Geselischaft zur Foerderung der angewandten Forschunge.V., Munich (DE)

(72) Inventors: Mehdi HAROUNABADI, Erlangen (DE); Martin LEYH, Erlangen (DE); Elke ROTH-MANDUTZ, Erlangen (DE); Shubhangi BHADAURIA, Erlangen (DE); Dariush MOHAMMAD SOLEYMANI, Erlangen (DE); Dietmar LIPKA, Erlangen (DE)

(21) Appl. No.: 18/160,916

(22) Filed: Jan. 27, 2023

Related U.S. Application Data
(63) Continuation of application No. PCT/EP2021/071803, filed on Aug. 4, 2021.

(30) Foreign Application Priority Data
Aug. 5, 2020 (EP) 20189709.7
Dec. 11, 2020 (EP) 20213530.7

(51) Int. Cl. H04W 40/22; H04W 40/24

(52) U.S. Cl. CPC H04W 40/22; H04W 40/24

(57) ABSTRACT

Embodiments provide a transceiver of a wireless communication system, wherein the transceiver is configured to operate in a sidelink in-coverage, out of coverage or partial coverage scenario, wherein the transceiver is configured to relay, in response to a reception of a sidelink relaying request and if one or more relaying criterions are fulfilled or pre-configured, signals in at least one direction between a remote transceiver and another transceiver of the wireless communication system.

### CROSS-REFERENCE TO RELATED APPLICATIONS

This application is a continuation of copending International Application No. PCT/EP2021/071803, filed Aug. 4, 2021, which is incorporated herein by reference in its entirety, and additionally claims priority from European Applications Nos. 20189709.7, filed Aug. 5, 2020 and EP 20213530.7, filed Dec. 11, 2020, which are all incorporated herein by reference in their entirety.

Embodiments of the present application relate to the field of wireless communication, and more specifically, to new radio sidelink relaying.

### BACKGROUND OF THE INVENTION

FIG. 1 is a schematic representation of an example of a terrestrial wireless network 100 including, as is shown in FIG. 1(a), a core network 102 and one or more radio access networks RAN1, RAN2, . . . RANn. FIG. 1(b) is a schematic representation of an example of a radio access network RANn that may include one or more base stations gNB1 to gNB5, each serving a specific area surrounding the base station schematically represented by respective cells 1061 to 1065. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANn may include more or less such cells, and RANn may also include only one base station. FIG. 1(b) shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1(b) shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g. via the S1 interface, via respective backhaul links 1141 to 1145, which are schematically represented in FIG. 1(b) by the arrows pointing to “core”. The core network 102 may be connected to one or more external networks. Further, some or all of the respective base station gNB1 to gNB5 may connected, e.g. via the S1 or X2 interface or the XN interface in NR, with each other via respective backhaul links 1161 to 1165, which are schematically represented in FIG. 1(b) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length. All OFDM symbols may be used for DL or UL or only a subset, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in an RRC connected state, so that the UEs do not receive from the base station any sidelink resource allocation configuration or assistance, and/or may be connected to the base station, but, for one or more reasons, the base station
may not provide sidelink resource allocation configuration or assistance for the UEs, and/or
may be connected to the base station that may not support NR V2X services, e.g. GSM, UMTS, LTE base stations.

When considering two UEs directly communicating with each other over the sidelink, e.g. using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3a is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3a which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 3b is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 3c is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In a communication system as described above, such as NR Rel-16, sidelink focuses on supporting V2X related road safety services, aiming to provide support for broadcast, groupcast and unicast communications in both out-of-coverage and in-network coverage scenarios. Besides these communication scenarios, there is a need for sidelink-based relaying functionality, especially for sidelink/network coverage extension and power efficiency improvement, considering wider range of applications and services.

From LTE a support of a UE-to-network relay and a UE-to-UE relay are known.

Support of UE-to-Network Relay

FIG. 3d shows a schematic view of an exemplary communication system comprising a UE and a network that are communicating with each other via a UE-to-network relay or via a direct communication [4].

As shown in FIG. 3d, a UE may act as a relay between a remote UE and the base station (e.g., gNB) to extend the coverage or improve the quality of service, etc. 5G ProSe needs to support UE-to-Network relay-based communication. A reference design for UE-to-Network relay is Rel-13 ProSe UE-to-Network relaying in LTE [1] which is L3-based. Another design model is a L2-based relay which is based on Rel-15 FeD2D SID in LTE [2].

FIG. 3e shows a schematic view of the protocol stack in a L3-based relay communication (protocol stack for ProSe 5G UE-to-Network Relay (L3) [4]). As shown in FIG. 3e, one of the solutions for a UE-to-Network and UE-to-UE relay is to apply a L3 relay. The following requirements have to be fulfilled by the relay node:
The ProSe 5G UE-to-Network Relay shall relay unicast traffic (UL and DL) between the Remote UE and the network.
The ProSe UE-to-Network Relay shall provide generic function that can relay any IP traffic.

FIG. 3f shows a schematic view of the control plane of a L2-based relay (user plane radio protocol stack for layer 2 evolved UE-to-Network relay (PC5) [2]), wherein FIG. 3g shows a schematic view of the data plane of a L2-based relay (control plane radio protocol stack for layer 2 evolved UE-to-Network relay (PC5) [2]). As shown in FIGS. 3f and 3g, another possibility is a L2 relay node. The requirements to be fulfilled by a L2 relay are as follows:
The L2 UE-to-Network Relay UE provides forwarding functionality that can relay any type of traffic over the PC5 link.
The L2 UE-to-Network Relay UE provides the functionality to support connectivity to the 5GS for Remote UEs. A UE is considered to be a Remote UE if it has successfully established a PC5 link to the L2 UE-to-Network Relay UE. A Remote UE can be located within NG-RAN coverage or outside of NG-RAN coverage.

Support of UE-to-UE Relay [5]

A UE-to-UE relay is a UE which exchanges message in one or both direction(s) between two remote UEs. The goal to employ such a relay UE share the same motivation for the UE-to-Network relay-based communication. The architecture for UE-to-UE relay can be L2 or L3 architecture same as UE-to-Network relay.

FIG. 3h shows a schematic view of an exemplary communication system comprising a remote UE communicating with a base station via a UE-to-Network relay and communicating with another remote UE via a UE-to-UE relay.

Starting from the above, there is a need for improvements or enhancements with respect to sidelink relaying procedures.

It is noted that the information in the above section is only for enhancing the understanding of the background of the invention and therefore it may contain information that does not form conventional technology and is already known to a person of ordinary skill in the art.

### SUMMARY

An embodiment may have a transceiver of a wireless communication system, wherein the transceiver is configured to operate in a sidelink in-coverage, out of coverage or partial coverage scenario, wherein the transceiver is configured to relay, in response to a reception of a sidelink relaying request and if one or more relaying criterions are fulfilled or pre-configured, signals in at least one direction between a remote transceiver and another transceiver of the wireless communication system, wherein the transceiver is configured to transmit an information element indicating that the transceiver is configured to act as relay.

Another embodiment may have a transceiver of a wireless communication system, wherein the transceiver is configured to operate in a sidelink in-coverage, out of coverage or partial coverage scenario, wherein the transceiver is configured to select, in dependence on one or more selection criterions, a relaying transceiver of the wireless communication system for relaying signals in at least one direction between the transceiver and another transceiver of the wireless communication system, wherein the transceiver is configured to communicate with the other transceiver by transmitting and/or receiving signals that are relayed by the selected relaying transceiver, wherein the transceiver is configured to transmit a sidelink relaying request to at least one candidate relaying transceiver of the wireless communication system, wherein the transceiver is configured to select a candidate relaying transceiver out of the at least one candidate relaying transceiver in dependence on the one or more selection criterions, to obtain the selected relaying transceiver, wherein a selection criterion of the one or more selection criterions is a PC5 link quality of the respective candidate relaying transceiver, wherein the PC5 link quality is based on one out of the following measurements: a received signal strength of a discovery message.

Another embodiment may have a transceiver of a wireless communication system, wherein the transceiver is configured to operate in a sidelink in-coverage, out of coverage or partial coverage scenario, wherein the transceiver is configured to select, in dependence on one or more selection criterions, a relaying transceiver of the wireless communication system for relaying signals in at least one direction between the transceiver and another transceiver of the wireless communication system, wherein the transceiver is configured to communicate with the other transceiver by transmitting and/or receiving signals that are relayed by the selected relaying transceiver, wherein the transceiver is configured, if one or more reselection conditions are fulfilled, to reselect a relaying transceiver of the wireless communication system for relaying signals in at least one direction between the transceiver and another transceiver of the wireless communication system in dependence on one or more selection or reselection criterions, wherein a reselection condition of the one or more reselection conditions is fulfilled when a reselection request from a higher layer of the transceiver or relaying transceiver is received.

Another embodiment may have a transceiver of a wireless communication system, wherein the transceiver is configured to operate in a sidelink in-coverage, out of coverage or partial coverage scenario, wherein the transceiver is configured to select, in dependence on one or more selection criterions, a relaying transceiver of the wireless communication system for relaying signals in at least one direction between the transceiver and another transceiver of the wireless communication system, wherein the transceiver is configured to communicate with the other transceiver by transmitting and/or receiving signals that are relayed by the selected relaying transceiver, wherein the transceiver is configured, if one or more reselection conditions are fulfilled, to reselect a relaying transceiver of the wireless communication system for relaying signals in at least one direction between the transceiver and another transceiver of the wireless communication system in dependence on one or more selection or reselection criterions, wherein a reselection condition of the one or more reselection conditions is fulfilled when one out of a PC5 link quality of the currently selected relaying transceiver is degraded, a Uu link quality of the currently selected relaying transceiver is degraded, a load of the currently selected relaying transceiver changes, a number of negative HARQ feedbacks of the currently selected relaying transceiver increases, a number of positive HARQ feedbacks of the currently selected relaying transceiver decreases, a radio link failure occurs, wherein thresholds of the one or more reselection conditions and/or their hysteresis are provided to the transceiver by pre-configuration.

According to another embodiment, a method for operating a transceiver of a wireless communication system may have the steps of: operating the transceiver in a sidelink in-coverage, out of coverage or partial coverage scenario, relaying, in response to a reception of a sidelink relaying request and if one or more relaying criterions are fulfilled or pre-configured, signals in at least one direction between a remote transceiver and another transceiver of the wireless communication system, transmitting an information element indicating that the transceiver is configured to act as relay.

According to another embodiment, a method for operating a transceiver of a wireless communication system may have the steps of: operating the transceiver in a sidelink in-coverage, out of coverage or partial coverage scenario, in which resources for a sidelink communication are pre-configured by the wireless communication system or allocated or scheduled autonomously by the transceiver, selecting, in dependence on one or more selection criterions, a relaying transceiver of the wireless communication system for relaying signals in at least one direction between the transceiver and another transceiver of the wireless communication system, communicating with the other transceiver by transmitting and/or receiving the signals that are relayed by the selected relaying transceiver, transmitting a sidelink relaying request to at least one candidate relaying transceiver of the wireless communication system, selecting a candidate relaying transceiver out of the at least one candidate relaying transceiver in dependence on the one or more selection criterions, to obtain the selected relaying transceiver, wherein a selection criterion of the one or more selection criterions is a PC5 link quality of the respective candidate relaying transceiver, wherein the PC5 link quality is based on one out of the following measurements: a received signal strength of a discovery message.

According to another embodiment, a method for operating a transceiver of a wireless communication system may have the steps of: operating the transceiver in a sidelink in-coverage, out of coverage or partial coverage scenario, in which resources for a sidelink communication are pre-configured by the wireless communication system or allocated or scheduled autonomously by the transceiver, selecting, in dependence on one or more selection criterions, a relaying transceiver of the wireless communication system for relaying signals in at least one direction between the transceiver and another transceiver of the wireless communication system, communicating with the other transceiver by transmitting and/or receiving the signals that are relayed by the selected relaying transceiver, reselect, if one or more reselection conditions are fulfilled, a relaying transceiver of the wireless communication system for relaying signals in at least one direction between the transceiver and another transceiver of the wireless communication system in dependence on one or more selection or reselection criterions, wherein a reselection condition of the one or more reselection conditions is fulfilled when a reselection request from a higher layer of the transceiver or relaying transceiver is received.

According to another embodiment, a method for operating a transceiver of a wireless communication system may have the steps of: operating the transceiver in a sidelink in-coverage, out of coverage or partial coverage scenario, in which resources for a sidelink communication are pre-configured by the wireless communication system or allocated or scheduled autonomously by the transceiver, selecting, in dependence on one or more selection criterions, a relaying transceiver of the wireless communication system for relaying signals in at least one direction between the transceiver and another transceiver of the wireless communication system, communicating with the other transceiver by transmitting and/or receiving the signals that are relayed by the selected relaying transceiver, reselecting, if one or more reselection conditions are fulfilled, a relaying transceiver of the wireless communication system for relaying signals in at least one direction between the transceiver and another transceiver of the wireless communication system in dependence on one or more selection or reselection criterions, wherein a reselection condition of the one or more reselection conditions is fulfilled when one out of a PC5 link quality of the currently selected relaying transceiver is degraded, a Uu link quality of the currently selected relaying transceiver is degraded, a load of the currently selected relaying transceiver changes, a number of negative HARQ feedbacks of the currently selected relaying transceiver increases, a number of positive HARQ feedbacks of the currently selected relaying transceiver decreases, a radio link failure occurs, wherein thresholds of the one or more reselection conditions and/or their hysteresis are provided to the transceiver by pre-configuration.

Another embodiment may have a non-transitory digital storage medium having a computer program stored thereon to perform any of the inventive methods for operating a transceiver of a wireless communication system, when said computer program is run by a computer.

### BRIEF DESCRIPTION OF THE DRAWINGS

Embodiments of the present invention will be detailed subsequently referring to the appended drawings, in which:

FIG. 1a-b shows a schematic representation of an example of a wireless communication system;

FIG. 2 is a schematic representation of an in-coverage scenario in which UEs directly communicating with each other are connected to a base station;

FIG. 3a is a schematic representation of an out-of-coverage scenario in which UEs directly communicating with each other receive no SL resource allocation configuration or assistance from a base station;

FIG. 3b is a schematic representation of a partial out-of-coverage scenario in which some of the UEs directly communicating with each other receive no SL resource allocation configuration or assistance from a base station;

FIG. 3c is a schematic representation of an in-coverage scenario in which UEs directly communicating with each other are connected to different base stations;

FIG. 3d shows a schematic view of an exemplary communication system comprising a UE and a network that are communicating with each other via a UE-to-network relay or via a direct communication [4];

FIG. 3e shows a schematic view of the protocol stack in a L3-based relay communication;

FIG. 3f shows a schematic view of the control plane of a L2-based relay;

FIG. 3g shows a schematic view of the data plane of a L2-based relay;

FIG. 3h shows a schematic view of an exemplary communication system comprising a remote UE communicating with a base station via a UE-to-Network relay and communicating with another remote UE via a UE-to-UE relay;

FIG. 4 is a schematic representation of a wireless communication system comprising a transceiver, like a base station or a relay, and a plurality of communication devices, like UEs, according to an embodiment;

FIG. 5 shows a schematic view of a communication system having two remote UEs and a UE-to-UE relay that bi-directionally relays signals between the two remote UEs;

FIG. 6 shows a schematic view of a communication system having two remote UEs and a UE-to-UE relay that uni-directionally relays signals from one of the remote UEs to the other of the remote UEs;

FIG. 7 shows a schematic view of a remote UE communicating over a UE-to-Network relay with a base station of the communication system, thereby reducing the needed transmit power; and

FIG. 8 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

The present invention provides approaches for improving the sidelink relaying procedures, so as to provide, for example, improvements, for example, in terms of power consumption, flexibility, complexity, forward compatibility, overhead, latency, robustness, reliability.

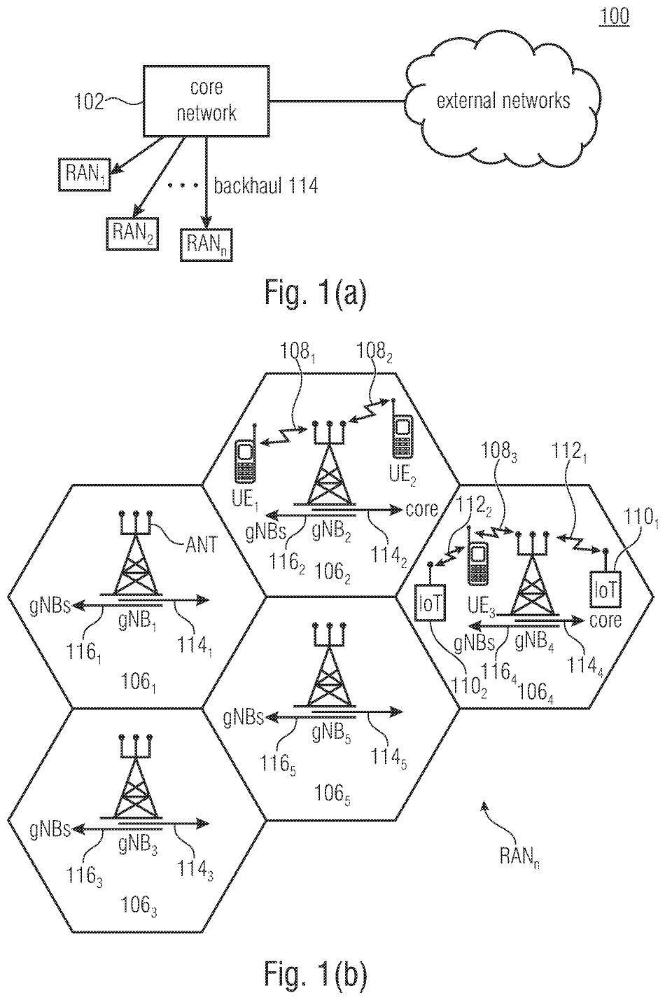

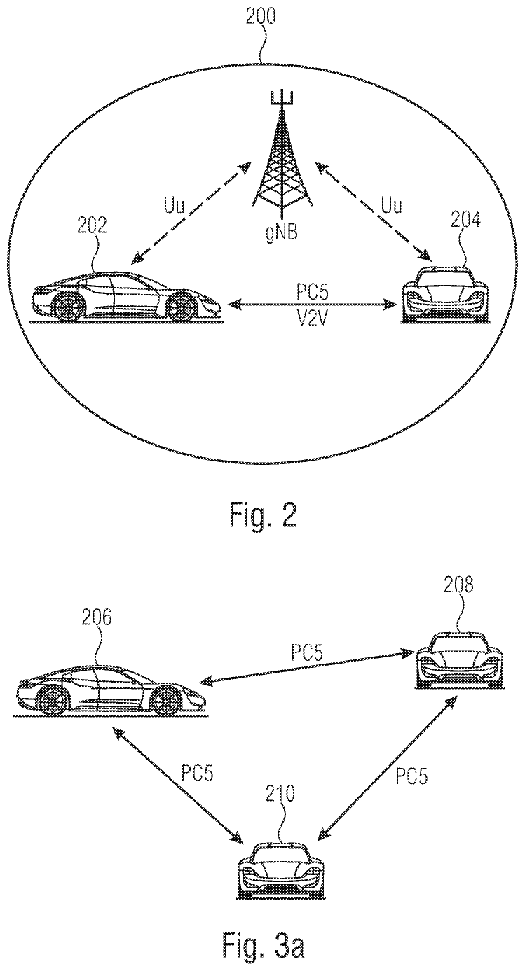

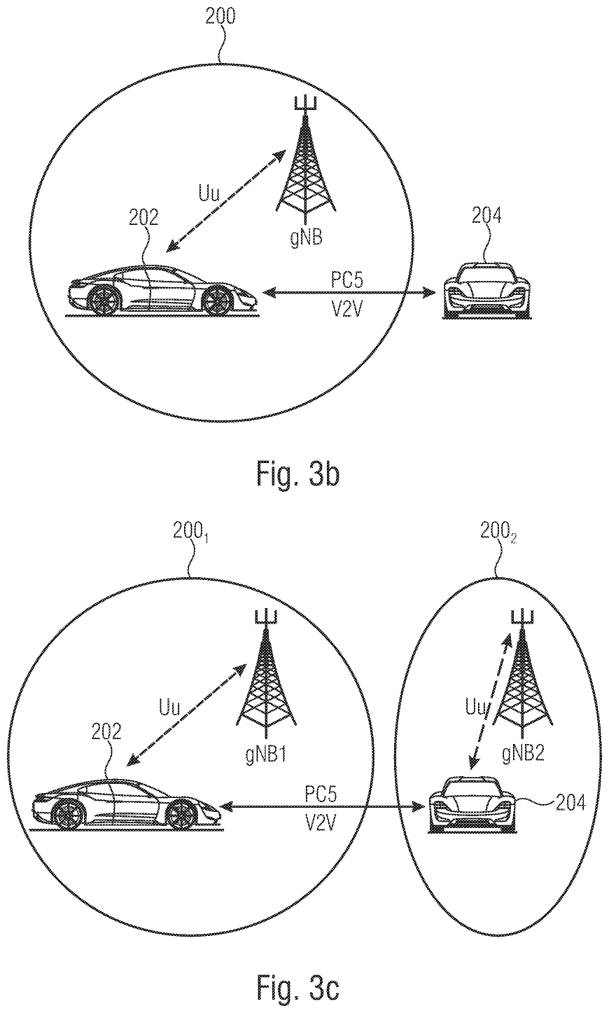

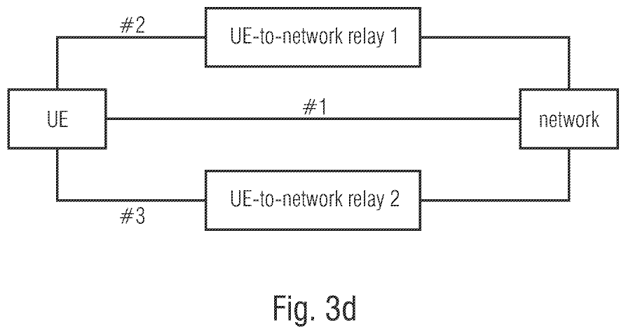

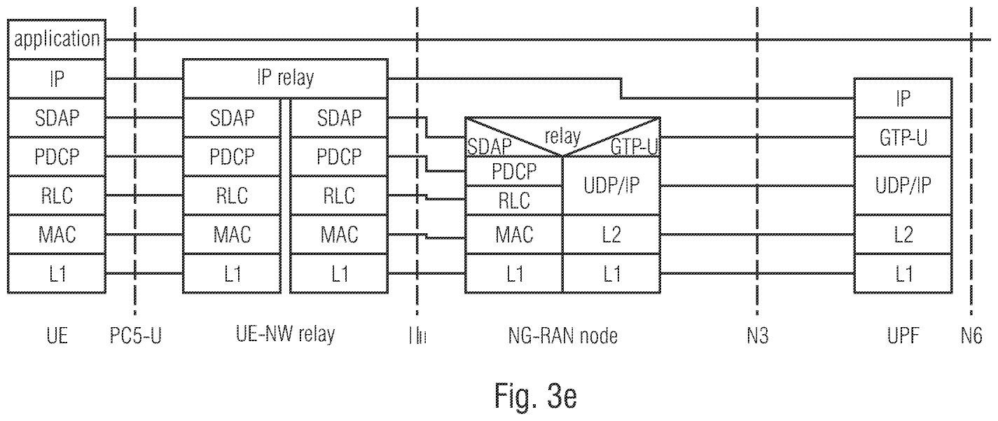

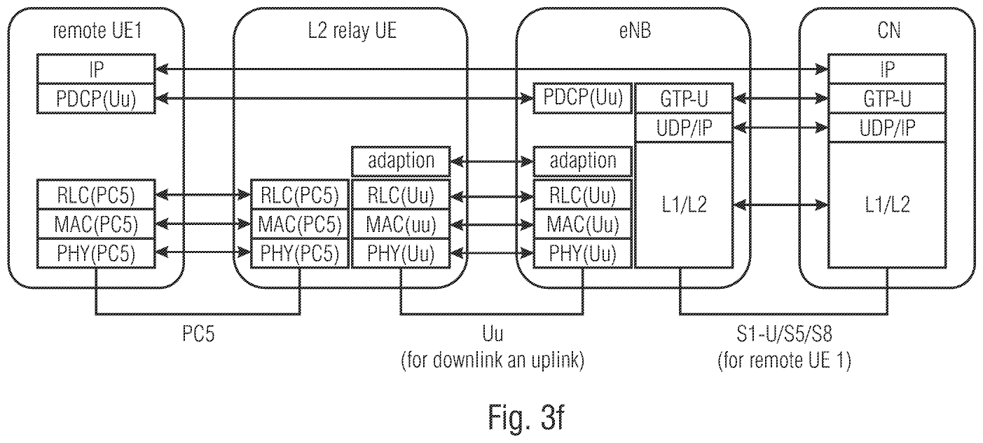

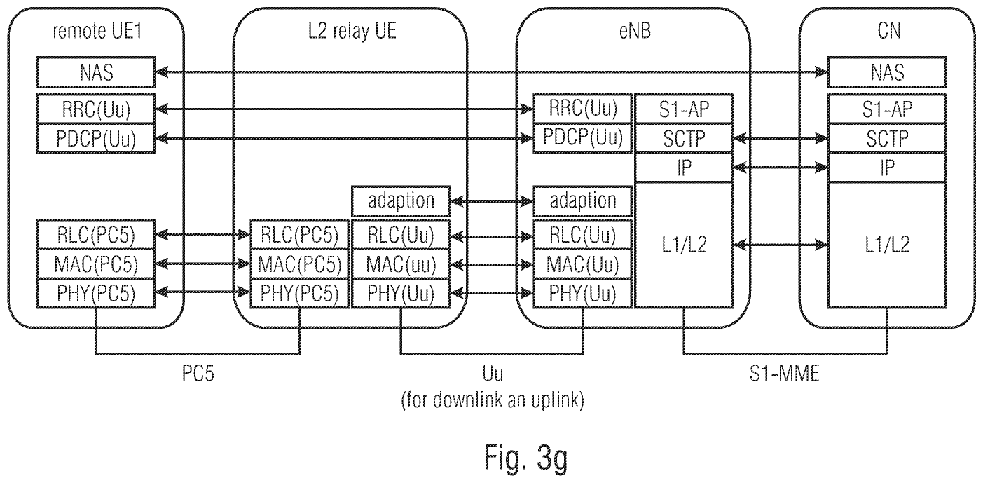

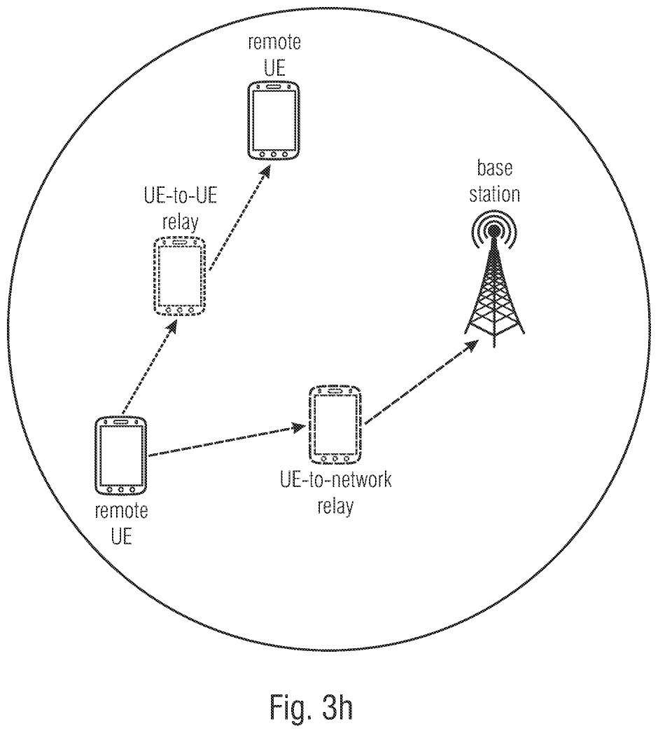

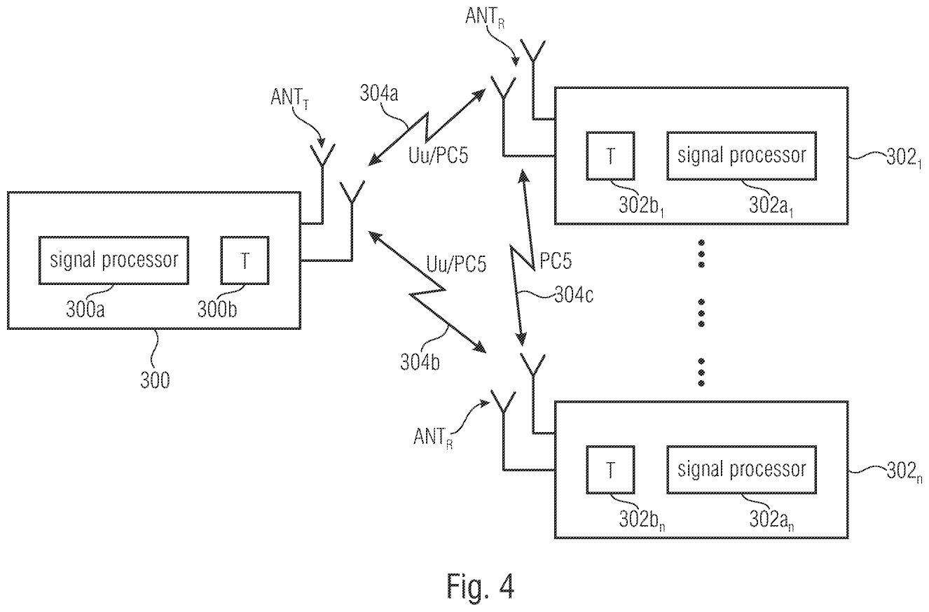

Embodiments of the present invention may be implemented in a wireless communication system as depicted in FIG. 1, FIG. 2, and FIGS. 3a-c including base stations and users, like mobile terminals or IoT devices. FIG. 4 is a schematic representation of a wireless communication system including a central transceiver, like a base station, and one or more transceivers 3021 to 302n, like user devices, UEs. The central transceiver 300 and the transceivers 302 may communicate via one or more wireless communication links or channels 304a, 304b, 304c, like a radio link. The central transceiver 300 may include one or more antennas ANTT or an antenna array having a plurality of antenna elements, a signal processor 300a and a transceiver unit 300b, coupled with each other. The transceivers 302 include one or more antennas ANTR or an antenna array having a plurality of antennas, a signal processor 302a1, 302an, and a transceiver unit 302b1, 302bn coupled with each other. The base station 300 and the UEs 302 may communicate via respective first wireless communication links 304a and 304b, like a radio link using the Uu interface, while the UEs 302 may communicate with each other via a second wireless communication link 304c, like a radio link using the PC5 interface. When the UEs are not served by the base station, are not be connected to a base station, for example, they are not in an RRC connected state, or, more generally, when no SL resource allocation configuration or assistance is provided by a base station, the UEs may communicate with each other over the sidelink. The system, the one or more UEs and the base stations may operate in accordance with the inventive teachings described herein.

Embodiments provide a transceiver [e.g., relaying UE] of a wireless communication system, wherein the transceiver is configured to operate in a [e.g., new radio, NR] sidelink in-coverage, out of coverage or partial coverage scenario [e.g., NR sidelink mode [e.g., mode 1 or mode 2]], [e.g., in which resources for a sidelink communication [e.g., transmission and/or reception and/or relaying] are pre-configured by the wireless communication system or allocated or scheduled autonomously by the transceiver], wherein the transceiver is configured [e.g., in a relay mode of operation] to relay, in response to a reception of a sidelink relaying request and if [e.g., all of] one or more relaying criterions are fulfilled or pre-configured [e.g., by a base station], signals in at least one direction between a remote transceiver [e.g., remote UE] and another transceiver [e.g., UE or base station] of the wireless communication system.

In embodiments, the transceiver is configured to relay the signals in the at least one direction between the remote transceiver [e.g., remote UE] and the other transceiver [e.g., UE or base station] using at least one out of dedicated or common resources of any resource pool [e.g. a common resource pool]

In embodiments, the transceiver is configured to receive the sidelink relaying request from remote transceiver.

In embodiments, the transceiver is configured to receive a relaying configuration to be used for relaying signals from a base station of the wireless communication network, and/or wherein the transceiver is configured to determine at least some parameters of a relaying configuration used for relaying signals autonomously.

In embodiments, the transceiver is configured to transmit a relaying confirmation to the remote transceiver [e.g., remote UE] and to start relaying the signals in the at least one direction between the remote transceiver [e.g., remote UE] and the other transceiver [e.g., UE or base station] in response to the transmission of the relaying confirmation, if the relaying criterion is fulfilled.

In embodiments, the transceiver is configured to directly start relaying the signals in the at least one direction between the remote transceiver [e.g., remote UE] and the other transceiver if the relaying criterion is fulfilled.

In embodiments, the transceiver is configured to indicate to the remote transceiver whether the relaying criterion is fulfilled by start transmitting or stop transmitting discovery messages or by transmitting a relaying status information describing whether the relaying criterion is fulfilled.

In embodiments, the transceiver is configured to operate [e.g., additionally to a remote UE mode of operation], in response to receiving the sidelink relaying request from the remote transceiver and if the relaying criterion is fulfilled, in a relaying mode of operation in which the transceiver [e.g., relaying UE] relays the signals in the at least one direction between the remote transceiver [e.g., remote UE] and the other transceiver.

In embodiments, a relaying criterion of the one or more relaying criterions indicates [or specifies] that the transceiver is selected by the remote transceiver as relaying transceiver [e.g., by a transmission of a relay selection confirmation].

In embodiments, a relaying criterion of the one or more relaying criterions indicates that at least one out of
a load of the traffic in the transceiver fulfills a [e.g., predefined] requirement,
a remaining battery level of the transceiver fulfills a [e.g., predefined] requirement,
a measured CR and/or CBR in the transceiver fulfills a [e.g., predefined] requirement,
the transceiver is able to fulfill a QoS requirement of the remote transceiver [e.g., remote UE [e.g., source or target UEs]],
a probability or risk [e.g. using prediction or artificial intelligence (AI)] that a transceiver may experience poor channel condition or poor coverage condition or may move into an out of coverage area.

In embodiments, the sidelink relaying request is initiated by
the remote transceiver [e.g., source UE],
the other transceiver [e.g., target or destination UE],
a road side unit, RSU, of the wireless communication system,
a base station of the wireless communication system, or
a group or cluster head or any UE group member of the wireless communication system.

In embodiments, the sidelink relaying request is transmitted through
an information element over PC5 [e.g., for a UE-to-UE RRC Information Element (IE)],
a unicast link establishment message [e.g., transmitted via the sidelink/PC5],
a discovery procedure of UEs,
an information element, IE, over Uu,
a direct link establishment,
an indication or a flag or one or several bits in the 1st or 2nd stage of SCI, or
an indication or a flag or one or several bits in the DCI,
a radio resource control, RRC, message,
piggy-backed on another type of message.

In embodiments, the transceiver is configured to transmit an information element [e.g., in the sidelink control information, SCI, such as in the first or second stage SCI] indicating that the transceiver is configured to act as relay.

In embodiments, the transceiver is configured to provide the relayed signals with an information element [e.g., in the higher layers]] indicating at least one out of
that the respective signal is a relayed signal,
that the transceiver is capable of acting as relay [e.g., capable of operating in a relaying mode of operation],
that the transceiver is acting as relay [e.g., operating in a relaying mode of operation].

In embodiments, the transceiver is configured to provide the relayed signals with an information in the sidelink control information, SCI, [e.g., number of status bits of the SCI, such as second stage SCI] indicating at least one out of
that the respective signal is a relayed signal,
that the transceiver is capable of acting as relay [e.g., capable of operating in a relaying mode of operation],
that the transceiver is acting as relay [e.g., operating in a relaying mode of operation].

In embodiments, the transceiver is configured to relay the signals in the at least one direction between the remote transceiver [e.g., remote UE] and the other transceiver [e.g., UE or base station] using relaying resources.

In embodiments, the relaying resources are configured by a base station, road side unit, RSU, or a group head.

In embodiments, the relaying resources are configured autonomously by the transceiver.

In embodiments, the relaying resources are one out of
resources dedicated for relaying,
at least partly overlapping the common resource pool for sidelink communication,
at least partly overlapping the common resource pool for uplink communication,
part of the resources that the transceiver [e.g., relaying UE] or the remote transceiver uses for sidelink or uplink communication.

In embodiments, the transceiver is configured to relay information describing mode 1 and/or mode 2 resource allocation between a base station and the remote transceiver.

In embodiments, the transceiver is configured to allocate or sub-grant its mode 1 and/or mode 2 resources to the remote transceiver

In embodiments, the transceiver is configured to determine the direction in which signals are relayed between the remote transceiver and the other transceiver based on at least one out of
a reliability requirement,
a latency requirement
a distance between the remote transceiver and the transceiver [e.g., relaying UE] or between the transceiver [e.g., relaying UE] and the other transceiver [e.g., gNB]
a CR and/or CBR,
a load of the traffic in the transceiver [e.g., relaying UE],
a RSRP and/or RSSI in the remote transceiver or other transceiver [e.g., gNB].

In embodiments, the transceiver is classified based on at least one out of
state [e.g. channel condition, load, battery level, distance to remote UE],
quality of service,
   wherein a traffic flow might be assigned to a relay UE based on the QoS requirement and class of relay UE.

In embodiments, the transceiver [e.g., relaying UE] is configured to only relay signals carrying information of the following type:
data messages, or
control messages, or
data and control messages, or
system information, SI [e.g., from a base station to the remote transceiver], or measurement reports [e.g., from the remote transceiver to the base station].

In embodiments, the transceiver [e.g., relaying UE] is configured to, in case that HARQ based communication is performed between the remote transceiver and the other transceiver, to only relay signals of said HARQ based communication carrying
HARQ feedback, and
HARQ retransmission.

In embodiments, the transceiver [e.g., relaying UE] is configured to, in case that HARQ based communication is performed between the remote transceiver and the other transceiver, and the transceiver [e.g., relaying UE] receives a HARQ NACK, to not relay said HARQ NACK but to perform the HARQ retransmission itself.

In embodiments, the transceiver [e.g., relaying UE] is configured to, in case that HARQ based communication is performed between the remote transceiver and the other transceiver, take over buffering of messages, sending feedback to the transceiver out of the remote transceiver and the other transceiver that is the HARQ source and retransmission of messages to the transceiver out of the remote transceiver and the other transceiver that is the HARQ destination.

In embodiments, the transceiver [e.g., relaying UE] is part of a group of transceivers, wherein the transceiver [e.g., relaying UE] is configured to relay signals between all of the transceivers of the group of transceivers and another transceiver that is not part of the group of transceivers [e.g., base station or head of another group of transceivers].

Further embodiments provide a transceiver [e.g., remote UE] of a wireless communication system, wherein the transceiver is configured to operate in a [e.g., new radio, NR] sidelink in-coverage, out of coverage or partial coverage scenario [e.g., NR sidelink mode [e.g., mode 1 or mode 2]], in which resources for a sidelink communication [e.g., transmission and/or reception] are pre-configured by the wireless communication system or allocated or scheduled autonomously by the transceiver, wherein the transceiver is configured to select, in dependence on [e.g., all of] one or more selection criterions, a relaying transceiver of the wireless communication system for relaying signals in at least one direction between the transceiver and another transceiver of the wireless communication system, wherein the transceiver is configured to communicate with the other transceiver [e.g., another UE, base station, road side unit] by transmitting and/or receiving the signals that are relayed by the selected relaying transceiver.

In embodiments, a selection criterion of the one or more selection criterions indicates that the selected relaying transceiver is an active relaying transceiver that relayed a signal from the other transceiver to the transceiver.

In embodiments, the transceiver is configured to transmit a sidelink relaying request to at least one candidate relaying transceiver of the wireless communication system, wherein the transceiver is configured to select a candidate relaying transceiver out of the at least one candidate relaying transceiver in dependence on the one or more selection criterions, to obtain the selected relaying transceiver.

In embodiments, a selection criterion of the one or more selection criterions indicates that a relaying response signal received from the selected relaying transceiver comprises the signal strength or a signal strength above a predefined threshold.

In embodiments, the transceiver is configured to transmit the sidelink relaying request to only those candidate relaying transceivers that comprise
a defined or (pre-)configured signal strength, or
the best signal strength, or
a signal strength above a predefined threshold.

In embodiments, a selection criterion of the one or more selection criterions is one out of
a Uu link quality of the respective candidate relaying transceiver,
a PC5 link quality of the respective candidate relaying transceiver,
a load in the respective candidate relaying transceiver,
a deliverable data rate of the respective candidate relaying transceiver,
a needed data rate of the transceiver,
a higher layer criteria of the transceiver [e.g., remote UE; e.g., relay UE]] [e.g., a criteria to select a relaying UE that comes from a higher layer of a remote UE] [e.g., a number of applications or virtual groups the relay has to support, i.e. w.r.t number of running applications],
an application layer criteria.

In embodiments, the PC5 link quality is based on one out of the following measurements:
a received signal strength of a discovery message,
a link quality of a PC5 unicast link [e.g., SL-RSRP, HARQ Feedback],
one or more probe messages between the transceiver and the candidate relaying transceiver [e.g., for channel state information or received signal strength measurements].

In embodiments, information needed for relay selection [e.g., PLMN ID, cell ID, RSRP] is exchanged between the transceiver and the relaying transceiver using at least one out of the following:
a unicast link establishment message [e.g., transmitted via the sidelink/PC5],
a discovery message,
a radio resource control, RRC, message,
piggy-backed on another type of message.

In embodiments, a selection criterion of the one or more selection criterions indicates that a QoS offered by the selected relaying transceiver fulfills a requested QoS requested by the transceiver.

In embodiments, the transceiver is configured, if one or more reselection conditions are fulfilled, to reselect [e.g., select another] a relaying transceiver of the wireless communication system for relaying signals in at least one direction between the transceiver and another transceiver of the wireless communication system in dependence on one or more selection or reselection criterions.

In embodiments, a reselection condition of the one or more reselection conditions is fulfilled when one out of
a PC5 link quality of the currently selected relaying transceiver is degraded [e.g., a PC5 signal strength falls below a (pre-)configured threshold],
a Uu link quality of the currently selected relaying transceiver is degraded [e.g., a Uu signal strength falls below a (pre-)configured threshold],
a load of the currently selected relaying transceiver changes [e.g., exceeds a (pre-) configured threshold],
a number of negative HARQ feedbacks of the currently selected relaying transceiver increases [e.g., exceeds a (pre-)configured threshold] [e.g., wherein the number of negative HARQ feedbacks is determined using a timer or a time window] [for example, a timer or time window might be considered to measure the number of feedbacks],
a number of positive HARQ feedbacks of the currently selected relaying transceiver decreases [e.g., falls below a (pre-)configured threshold]] [e.g., wherein the number of negative HARQ feedbacks is determined using a timer or a time window] [for example, a timer or time window might be considered to measure the number of feedbacks],
a radio link failure occurs,
a reselection request from a higher layer of the transceiver or relaying transceiver is received.

In embodiments, thresholds of the one or more reselection conditions [e.g., thresholds of measurements such as RSRP of PC5 unicast link, RSRP of discovery messages] and/or their hysteresis are provided to the transceiver by pre-configuration or by a base station [e.g., gNB] [e.g., through SIB, RRC, etc.].

In embodiments, a selection/reselection criterion of the one or more selection criterions indicates that a distance or based on geographical position [e.g. of the target and/or source UE] between the transceiver [e.g., remote UE [e.g., source UE]], the other transceiver [e.g., destination UE] and the selected relaying transceiver fulfills a requested distance or geographical position is meeting a threshold condition of a defined distance or geographical position expected or requested or (pre-)configured by the transceiver.

In embodiments, a selection/reselection criterion of the one or more selection criterions indicates that a relative speed [e.g. based on the current speed of both the source and target UE] between the transceiver [e.g., remote UE], the other transceiver and the selected relaying transceiver fulfills a requested relative speed or is meeting a threshold condition of a defined speed.

In embodiments, a selection/reselection criterion of the one or more selection criterions indicates that a moving direction between the transceiver [e.g., remote UE], the other transceiver and the selected relaying transceiver fulfills a requested moving direction expected or requested or (pre-)configured by the transceiver.

In embodiments, the transceiver is configured to select or reselect a candidate relaying transceiver out of a list of candidate relaying transceivers.

In embodiments, the transceiver is configured to update the list of candidate relaying transceivers by measuring signal strengths of signals received from transceivers in the proximity.

In embodiments, the transceiver is configured to select the relaying transceiver out of a list of one or more relaying transceivers that fulfill the one or more selection criterions.

In embodiments, the list of one or more relaying transceivers includes those transceivers out of a list of candidate relaying transceivers that fulfill the one or more selection criterions.

In embodiments, the transceiver is configured to transmit a relaying selection information to a central transceiver [e.g., base station] of the wireless communication system informing the central transceiver about the selected relaying transceiver.

In embodiments, the transceiver is configured to select the relaying transceiver out of the list of one or more relaying transceivers in dependence on a relaying selection assistance information received from a central transceiver [e.g., base station] of the wireless communication system assisting the transceiver in the selection of the relaying transceiver.

In embodiments, the transceiver is configured to transmit a relaying deselection message to the selected relaying transceiver, if a relaying termination criterion is fulfilled [e.g., relaying of signals is not more needed and/or relaying of signals is not needed any more and/or a QoS requirement is not provisioned].

In embodiments, the transceiver is configured to keep a list of remote transceivers that have requested the transceiver to act as s relay transceiver and stop acting as relay transceiver if the list is empty and/or after all have deselected.

In embodiments, the transceiver is configured to receive an information element indicating that a specific transceiver of the wireless communication system is a candidate relaying transceiver [i.e. is configured to act as relay].

In embodiments, the transceiver is configured to receive the information element from the candidate relaying transceiver [e.g., via the sidelink control information, SCI, such as the second stage SCI].

In embodiments, the transceiver is configured to receive the information element from a higher layer [e.g., via RRC].

In embodiments, the transceiver is configured to transmit a sidelink relaying request to the candidate relaying transceiver indicated by the received information element [e.g., in response to the reception of the information element].

In embodiments, the transceiver is configured to recognize that a relaying is needed for communicating with the other transceiver based on at least one QoS indicator, wherein the transceiver is configured to select the relaying transceiver and communicate with the other transceiver via the relaying transceiver in response to recognizing that a relaying is needed.

In embodiments, the at least one QoS indicator is at least one out of
a number of HARQ retransmissions,
a RSSI or RSRP,
a block error rate.

In embodiments, a selection criterion of the one or more selection criterions is that a transmit power needed for transmitting signals to the candidate relaying transceiver is smaller than a needed transmit power for transmitting signals to the other transceiver.

In embodiments, a selection criterion of the one or more selection criterions is that a distance to the candidate relaying transceiver is smaller than a distance to the other transceiver.

In embodiments, the transceiver is configured to select, in dependence on [e.g., all of] one or more selection criterions, for a limited or configured time, two or more relaying transceivers of the wireless communication system for relaying signals in at least one direction between the transceiver and another transceiver of the wireless communication system.

In embodiments, the transceiver is configured, if a relaying handover condition is fulfilled, to handover the relaying of signals in at least one direction between the transceiver and another transceiver from one selected relaying transceiver of the two or more selected relaying transceivers to another selected relaying transceiver of the two or more selected relaying transceivers [e.g., to support service continuity].

In embodiments, the relaying handover condition is one out of
a radio link failure,
mobility,
a bad channel condition [e.g., received signal strength falls below a (pre-)defined threshold].

Further embodiments provide a method for operating a transceiver [e.g., relaying UE] of a wireless communication system. The method comprises a step of operating the transceiver in a [e.g., new radio, NR] sidelink in-coverage, out of coverage or partial coverage scenario [e.g., NR sidelink mode [e.g., mode 1 or mode 2]], [e.g., in which resources for a sidelink communication [e.g., transmission and/or reception and/or relaying] are pre-configured by the wireless communication system or allocated or scheduled autonomously by the transceiver]. Further, the method comprises a step of relaying [e.g., in a relay mode of operation], in response to a reception of a sidelink relaying request and if [e.g., all of] one or more relaying criterions are fulfilled or pre-configured [e.g., by a base station], signals in at least one direction between a remote transceiver [e.g., remote UE] and another transceiver [e.g., UE or base station] of the wireless communication system.

Further embodiments provide a method for operating a transceiver [e.g., remote UE] of a wireless communication system. The method comprises a step of operating the transceiver in a [e.g., new radio, NR] sidelink in-coverage, out of coverage or partial coverage scenario [e.g., NR sidelink mode [e.g., mode 1 or mode 2]], in which resources for a sidelink communication [e.g., transmission and/or reception] are pre-configured by the wireless communication system or allocated or scheduled autonomously by the transceiver. Further, the method comprises a step of selecting, in dependence on [e.g., all of] one or more selection criterions, a relaying transceiver of the wireless communication system for relaying signals in at least one direction between the transceiver and another transceiver of the wireless communication system. Further, the method comprises a step of communicating with the other transceiver [e.g., another UE, base station, road side unit] by transmitting and/or receiving the signals that are relayed by the selected relaying transceiver.

Relays can be used to overcome coverage gaps. In general, a relay has two transceivers, one acting as a mobile air interface towards an eNB, the other acting like an eNB air interface to forward the mobile radio connection into the area that suffers insufficient coverage by the eNB connected to the UE end of the relay.

Comparable situations occur in NR V2X mode 2 operation, where sidelink has to be used if at least one UE in unicast/groupcast/broadcast is out of coverage from the gNB and other UEs. A common problem, especially in urban areas, is shadowing occurring, e.g., at street crossings, intersections or junctions surrounded by buildings. In such scenarios, the communication between vehicles and vulnerable road users (VRU), i.e. pedestrians, cyclists, etc., can be critical, for example, when collision warnings from fast moving vehicles shall be transmitted. In urban areas that may become even more critical, due to the high number of road users. If a UE transmits, a critical message, for example an emergency vehicle, all members might not decode the message if they are around corners shadowed by buildings.

In other words, the coverage by other UEs is generally different for each UE. For example, while UE-B is well covered by UE-A, UE-C may not. The consequences are
multiple distributed relay UEs have to be considered in general, and
relay selection/reselection.

Likewise, relaying is a solution for V2X as well to compensate insufficient coverage of certain road users by a corresponding transmitting UE. Other benefits of relays might be as follows [5]:

increased data rate,
enhanced reliability,
reduced latency,
support of new carrier frequencies and operation scenarios,
power saving,
spectral efficiency enhancement, and/or
sidelink coverage enhancement.

Compared to conventional relays, which are managed statically through localization and network planning, the following points are addressed in embodiments for relay-based communication in 5G:
Relay selection criteria, procedures and signaling (section 1)
   Triggering relay action
   Response to a relay request
   Relay (re/de-)selection procedures
   Sidelink measurement/reporting/feedback
   Selection criteria
   Association of remote UEs with their relay UE
      Possibly providing a sub-groupcast, i.e. a relay UE maintains a list of its remote peers and addresses its relayed transmission to them
      Coordinating overlapping sub-groups (this has a relation to message duplicates in the above)
Relay capability signaling for new capabilities (section 2Fehler! Verweisquelle konnte nicht gefunden werden.)
   Recognition of the relay status. Recognition of availability of relay capable UEs (if no relay capable UEs are reachable corresponding messages like relay requests should be omitted to avoid unnecessary load on the radio resources)
   Recognition of UEs already acting as relays (with that unnecessary relay requests can also be avoided)
   Recognition of the need for a relay. This is an issue if a UE is not able to decode the SCI of a transmitting UE and thus is not aware that it needs a relay
QoS of relay-based communication (section 3)
   Recognition of the need for relay-based communication
   Resources for relay based communication
   Uni-bidirectional relaying
   Classification of relay UEs
   Coordination of multiple relay UEs to handle issues like
      Transmission of duplicates of the same message multiple times
      Identification that a message is a duplicate and can be ignored if it already has been decoded previously
   How to apply Relay UE-gNb QoS to QoS on PC5
   Guarantee end-to-end QoS
User Plane and Control Plane enhancements for NR Sidelink Relay (section 4)
   Relay UE for data or control messages (or both)
Other aspects of relay-based communication (section 5))
   Other aspects of relay-based communication
   Relay-based group communication
   Power saving through relay-based communication
   HARQ procedure in a relay-based communication
   Groupcast relaying

Embodiments provide NR/5G sidelink-based relaying functionality, which is needed for sidelink/network coverage extension and power efficiency improvement, considering wider range of applications and services.

This includes the coverage extension for sidelink-based communication, i.e.
UE-to-network coverage extension: Uu coverage reachability is needed for UEs to reach server in PDN network or counterpart UE out of proximity area. However, release-13 solution on UE-to-network relay is limited to EUTRA-based technology, and thus cannot be applied to NR-based system, for both NG-RAN and NR-based sidelink communication.
UE-to-UE coverage extension: Currently proximity reachability is limited to single-hop sidelink link, either via EUTRA-based or NR-based sidelink technology. However, that is not sufficient in the scenario where there is no Uu coverage, considering the limited single-hop sidelink coverage.

Overall, sidelink connectivity needs an extension within the NR framework, in order to support the enhanced QoS requirements.

Embodiments described herein support the SA requirements for sidelink-based UE-to-network and UE-to-UE relay. Embodiments described herein focus on or more of the following aspects for layer-3 relay and layer-2 relay [RAN2]:
Relay (re-)selection criterion and procedure;
Relay/Remote UE authorization;
QoS for relaying functionality;
Service continuity;
Security of relayed connection after SA3 has provided its conclusions;
Impact on user plane protocol stack and control plane procedure, e.g., connection management of relayed connection;

Embodiments described herein support upper layer operations of discovery model/procedure for sidelink relaying, assuming no new physical layer channel/signal [RAN2].

In embodiments, it is assumed that UE-to-network relay and UE-to-UE relay use the same relaying solution.

In embodiments, forward compatibility for multi-hop relay support in a future release needs is taken into account.

In embodiments, for layer-2 UE-to-network relay, the architecture of end-to-end PDCP and hop-by-hop RLC, e.g., as recommended in TR 36.746, is taken as starting point.

In embodiments, the following definition in context of relay is applicable:
UE-to-Network Relay UE (or just as shortend version Relay UE): A UE that provides functionality to support connectivity to the network for Remote UE(s).
Remote UE: A (relay-enabled) UE that communicates with a DN via a UE-to-Network Relay.

Subsequently, embodiments of the present invention are described in further detail.

### 1. Relay (Re-, De-)Selection Criteria and Procedures

1.1 Relay UE Selection

In embodiments, if a UE detects the need for relay assistance, two case have to be distinguished:
1. At least one relay UE is active
2. No relay UE is active

In the first case, the remote UE selects and listens to at least one of the relays.

In the second case, before the remote UE can listen to a relay, it has to request another UE to assist as relay. Thereby, two types of requests can be specified:
A. A first type of request is to broadcast a request
B. A second type of requests is to send a dedicated request to a specific UE

The advantage of the first type of request (broadcast request) can be seen as a best effort that does not need the information about relay capable UEs. Thus, the signaling overhead is reduced or even minimized. The disadvantage is that all relay capable UEs that decode the request will blindly switch to relay mode so that a message is relayed multiple times thus generating multiple duplicates that waste sidelink resources. To avoid this disadvantage the relay request procedure can be extended by a handshake between UEs before the start of relaying:
1. Relay-capable UEs respond to the UE requesting a relay with a request to confirm the relay
2. The UE will confirm only to the UE with e.g. the best signal strength

The advantage of the second type of request (dedicated request) is the minimized number of duplicates. The cost is a higher signaling overhead since target identities have to be conveyed and analyzed.

The following relay (re-)selection procedure is equal for both cases 1 and 2 above.

The relay UE selection can be partly reused from the procedures known from cell selection in idle mode. For V2X, relay UE selection is based on SCI decoding, and any combination of the measurements of SCH, RSRP and RSSI strength.

The SCI is needed to obtain the identity of a candidate UE associated with its measurements. A remote UE sets up a list of candidates and applies a relay UE criterion that may be copied from the classical cell selection criterion. The relay UE is in this sense playing the role of a cell. The relay (re-)select procedure could be:

The Remote UE (looking for a Relay UE)
1. measures the signal strength of UEs in proximity,
2. sends a “relay request” to the UE with best RSS (or multiple UEs with acceptable RSS (threshold) or broadcast with list of “acceptable” UEs for relaying,
   the relay request may include the needed QoS (e.g. any combination of latency, priority, reliability)

Any receiving Relay UE(s)
1. confirms/responds and/or
   the confirming/responding Relay UEs are relay capable and/or relay enabled
   the response/confirmation may include the offered QoS (e.g. any combination of latency, priority, reliability)
2. directly serves as Relay UE.

Optionally, the Remote UE
1. may confirm the Relay UE (e.g. based on the offered QoS).

Optionally, only the Relay UE—when receiving the confirmation—will serve as relay (case A).

Prerequisite of the measurements can be that synchronization to the sidelink of all other UEs, i.e. the synchronization procedure on SSB is completed. However, unlike classical cell selection, where the SSB and measurements are associated with the same cell, in V2X the SSB can be sent from another UE than the measured one. That means the SCI decoding is the V2X counterpart of the background cell search to obtain the identities associated with the measurements.

1.2 Relay Selection Criteria

In embodiments, for selecting a relay UE, at least one of the following criteria can be considered:
The Uu link quality of a candidate relay UE
A PC5 link quality based on at least one out of the following radio link measurements:
   The received signal strength of discovery messages
   The link quality of PC5 unicast link e.g. SL-RSRP, HARQ feedback
   One or several probe messages between two UEs (a remote UE and a relay UE) for channel state estimation or received signal strength measurement
The load in a relay UE
The needed data rate of the remote UE
Based on the higher layer criteria (e.g. number of applications or virtual groups the relay has to support i.e. w.r.t number of running applications)
Based on the AS layer criteria

In embodiments, the information needed for relay selection (i.e. to be considered as a relay selection criteria) such as PLMN ID, cell ID, RSRP, etc. can be exchanged between a remote UE and a candidate relay UE using at least one out of the following:
Through messages of PC5 unicast link establishment (i.e. extra fields in the PC5 link establishment messages)
Discovery messages
RRC messages
Any other type of messages
Piggy-backed on other types of messages

1.3 Response to a Relay Request

In embodiments, conditions to accept a relaying request from a remote UE (a UE accepts/declines to be a relay node) are one or more of the following:
Load of the traffic in a relay node
Remaining battery level
Measured CR and CBR in relay node
Ability to fulfil the QoS requirements of a remote UE (for a certain flow)

In embodiments, a relay UE may reveal its response by transmitting/stopping discovery messages or through any other types of messages.

1.4 Triggering Relaying Action in a Candidate Relay UEs (by Sending Request)

In embodiments, the request for a relay-based communication might be triggered by at least one of the following entities:
By transmitter UE (or, e.g., source UE)
By receiver UE (or, e.g., target or destination UE)
By RSU (or any other communication facility in a road)
By base station (e.g., gNB)
By a group or cluster head

In embodiments, the options for triggering a relay-based communication or selecting a UE-to-UE or UE-to-Network relay might be at least one of following options
An information element over PC5 (e.g., a UE-to-UE RRC Information Element (IE))
Through discovery procedure of UEs
An IE over Uu
Through direct link establishment
Through an indication or a flag or one or several bits in the 1st or 2nd stage of SCI
Through an indication or a flag or one or several bits in the DCI

1.5 Relay UE Reselection

In embodiments, the relay UE list build up for selection is also the basis for reselection decisions. After selection the remote UE maintains the list by collecting and updating SCI and measurement data continuously. The relay UE reselection can be partly reused from the procedures known from cell reselection in idle mode. Cell reselection involves a hysteresis that will be adapted for V2X relay-UE reselection.

In embodiments, the thresholds of measurements such as RSRP of PC5 unicast link, RSRP of discovery messages and their hysteresis for relay (re-) selection can be provided to the UEs by pre-configuration or by gNB through, for example, SIB, RRC and etc.

1.6 Relay Reselection Trigger

In embodiments, the relay reselection may be triggered when at least of the following condition is met:
The PC5 link quality is degraded (e.g., the signal strength is below a (pre-)configured threshold)
The Uu link in relay UE is degraded (e.g., the signal strength is below a (pre-)configured threshold)
The load in relay UE is changed (e.g., the relay UE becomes overloaded)
The number of negative HARQ feedbacks (NACKs) increases (e.g., more than a (pre-) configured threshold or the number of positive feedbacks reduces (ACKs) (for e.g. below a (pre-)configured threshold). A timer or time window might be considered to measure the number of feedbacks
A Radio Link Failure (RLF) occurs
A request from higher layer of remote UE or relay UE

1.7 Multiple Connections in a Remote UE with More than One Relay

In embodiments, a remote UE or gNB might select more than one relay node for UE-to-UE or UE-to-Network relaying for a limited or configured time. In case of the need for a handover from one relay to another relay (e.g., due to RLF, mobility, bad channel condition), the remote UE might have two active connections with at least two relay UEs to support service continuity.

1.7.1 Relay UE Deselection

Relay-UE deselection has no counterpart in conventional cell idle mode. It is important for V2X that relays are inactive if not needed to avoid unnecessary load on the sidelink channel by duplicate messages. That means each remote UE is obliged to send an information element to deselect its relay UEs. Of course, this will not stop all relays right away since other UEs may still need it. However, if all remote UEs have sent the deselection information all relay operation is stopped.

Therefore, in embodiments, each relay UE maintains another list with the remote UEs it is responsible for.

1.8 Relay and Remote UE Lists

As explained above, in embodiments, two list can be maintained:
List of relay UEs
List of remote UEs

In embodiments, both lists can be maintained by relay capable UEs. The list of relay UEs since it may also be in need for assistance, the list of remote UEs to be aware if it can stop the relay function. In embodiments, UEs not capable of relaying can maintain only the list of relay-UEs.

If it makes sense to define relay-only devices. Those would only need the list of remote-UEs. Such devices could be RSUs, which are static like conventional relays. They would also not care about original messages they cannot receive from UEs hidden to them.

A UE requesting another UE to function as a relay may consider cell (re-)selection procedure as basic procedure for relaying UE (re-)selection, e.g., based on received signal strength (e.g., RSRP, . . . ), e.g., on SB.

1.9 (Re-)Selection of a Relay from the List of Candidate Relay UEs

In embodiments, the list of relay UEs is made based on the candidate relay UEs which meet the relay selection criteria (e.g., AS layer and higher layer criteria). A remote UE may select a relay UE up to its implementation from the candidate relay UEs in the list. In addition, the UE might inform the gNB about its relay reselection or let the gNB be involved in relay re-selection using the list of relay UEs.

### 2. Relay Capability Signaling

2.1 Recognition of Availability of Relay Capable UEs

In embodiments, an Information element (RRC) indicating that a UE has relay capability can be multiplexed with data in higher layers or as one bit in SCI, advantageously stage 2. This allows omitting relay specific signaling, thus avoiding unnecessary load for the sidelink resources.

If a relay capable UE is detected a UE that needs assistance by a relay sends a relay request. The relay request includes the identity of the remote UE so that the relay-UE sets up a list of all requesters. This list represents a subgroup of requesting remote UEs. The relay-UE can address this subgroup directly. Thus, UEs not belonging to the subgroup can skip HARQ feedbacks to the relay UE.

2.2 Recognition of UEs Acting as Relays

In embodiments, Recognition of UEs acting as relays, can be done indirectly during a relay transmission opportunity. For example, an Information element indicating that a message is duplicated by a relay operation can be multiplexed with the relayed message in higher layers. With that, the message is inherently marked as duplicate that UEs, which have successfully decoded the original message, can ignore it.

Another information element can inform when a UE is acting as a relay or not. This allows omitting relay specific signaling, specifically requests to enter relay mode, thus avoiding unnecessary load for the sidelink resources.

Alternatively, a number of status bits, which inform about the relay, can extend the SCI, advantageously SCI stage 2. For example, the status bits or information element can inform about one or more of the following:
Message is relayed
UE is acting as relay
UE is relay capable
e.t.c.

As mentioned above, these information elements and/or status bits, in an advantageous solution, can be transmitted on a transmission opportunity. That means, only if a message is sent by the relay capable UE either as original or relayed. In other words, a transmission only for the purpose to inform about the relay status shall be avoided.

The option of transmissions with the relay status, only, is not excluded, although it adds load to the sidelink resources.

2.3 UE Capability

In embodiments, “relaying” is defined as new UE capability. Thereby, note that in NR, there are no UE categories as in LTE, but there are UE features.

### 3. QoS for Relaying Functionality

3.1 Recognition that a Relay is Needed

In embodiments, if SCI can be decoded, a criterion that relay assistance is needed can be, for example, a high number of HARQ retransmission or high block error rate. Another criterion is low RSRP below a certain threshold measured from corresponding UEs.

If SCI cannot be decoded, the criterion can be a measurement, e.g., RSRP, etc..

A lower RSRP threshold is needed to decide if the measurement can be interpreted as an existing transmission or if there was only noise, i.e. there was no transmission:
High number of HARQ retransmissions (e.g. high number of NACK in remote UE)
Low RSSI or RSRP at remote UE, gNB
High block error rate

3.2 Resources for Relaying

In embodiments, the resources for relaying which are used by the relay node can be configured by the base station (e.g., gNB), RSU, group (cluster) head or by UEs autonomously. The relaying resources can be completely dedicated for relaying or (partly) overlapped with the common resource pool for sidelink or uplink communication. A UE may access to the resources for the relaying resource pool if acts as a UE-to-network or UE-to-UE relay. The resources for the relay node can be:
Pre-configured resources which the base station (e.g. gNB), RSU, group (cluster) head defines
Part of the resources from the resource pool which UEs use for sidelink or uplink communication. In this case, UEs allocate part of their resources (which they have reserved in mode 2 or obtained from gNB in mode 1 resource allocation) to the relay node to assist them.

In embodiments, the relay UE may also relay information about the mode 1/mode 2 resource allocation between gNB and remote UE(s). The relay UE may allocate or sub-grant its mode 1/mode 2 (reserved) resources to the remote UE(s).

3.3 Unidirectional or Bidirectional Relaying

In embodiments, A UE-to-UE or UE-to-Network relay may relay messages only uni-directional or bi-directional. The decision may be done based on the at least one of the following conditions:
Reliability requirement
Latency requirement
Distance between remote UE and relay UE or between relay UE and gNB
CR and CBR
Load of the traffic in relay UE
RSRP, RSSI in transmitter UE or receiver UE or gNB

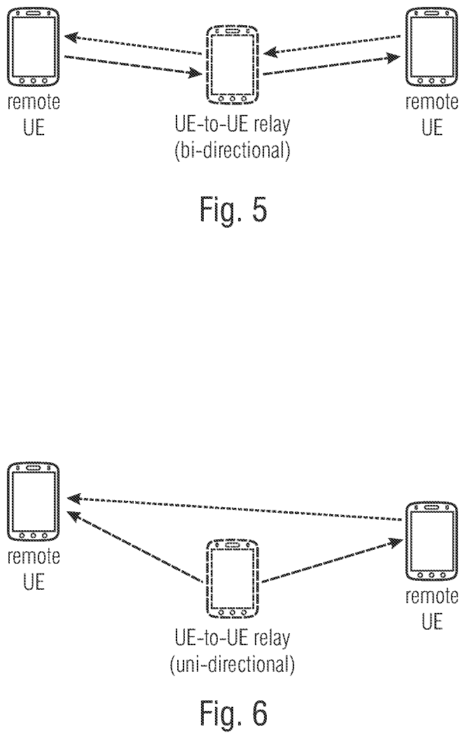

FIG. 5 shows a schematic view of a communication system having two remote UEs and a UE-to-UE relay that bi-directionally relays signals between the two remote UEs.

FIG. 6 shows a schematic view of a communication system having two remote UEs and a UE-to-UE relay that uni-directionally relays signals from one of the remote UEs to the other of the remote UEs.

3.4 Classification of Relay Nodes

In embodiments, relay nodes can be classified based on their states and different flow of traffic might be assigned to different class of relays.

### 4. User Plane and Control Plane for Sidelink Relay (e.g., Connection Management)

4.1 Relay UE for Data or Control Messages (or Both)

In embodiments, a UE-to-UE or UE-to-Network relay may be employed in a network for at least one of the following type of information:
To relay data messages only
To relay control messages (e.g. results of the sensing procedure, exchange of resources between UE, resource allocation information, inter-UE coordination messages, paging of a remote UE, signaling)
To relay both data and control messages
To relay SI from gBN to remote UE(s)
To relay measurement reports for UE(s) to gNB

### 5. Other Aspects of Relay-Based Communication

5.1 HARQ Procedure in Relay-Based Communication

In embodiments, un case of relay-based communication, the HARQ procedure may be at least one of the following options:
End-to-end HARQ: in this option, there is an end-to-end HARQ procedure between source (transmitter) UE and the target (destination) UE. The relay node only forward the HARQ feedback and retransmission between source and destination UEs.
   In this case, the relay node may take over the retransmission of messages in case of receiving NACK instead of relaying the NACK to the source UE. To enable this option, messages have to be stored in the relay node after relaying until one of the following options:
      ▪ Receiving an ACK.
      ▪ For a limited time (for e.g. until a timer expires).
Hop-by-hop HARQ: in this option, the HARQ procedure is divided into two independent procedures. The relay node takes over buffering of messages, sending feedback to the source UE and retransmission of messages to the destination UE.

5.2 Groupcast Relaying

For groupcast communication, relaying may be used in such a way, that only one UE within the group receives and transmits messages to the gNB or other groups. This UE serves as Groupcast Relay UE to all other group members. All other UEs of the group are Groupcast Remote UEs, exchanging messages via the Groupcast Relay UE only.

One advantage is that all groupcast remote UEs might save battery energy.

5.3 Tx Power Reduction Applying the Relay-Based Communication for Energy Saving

In embodiments, a UE may reduce its transmission power by selection of other UEs as relay to save energy. As the relay UE is closer to the transmitter UE than the receiver UE, the transmitter UE may reduce its transmission power.
The selection of a UE-to-UE relay or UE-to-Network relay by a transmitter UE, receiver UE or gNB can be based the distance between the transmitter UE and the relay or the relay and the receiver UE.

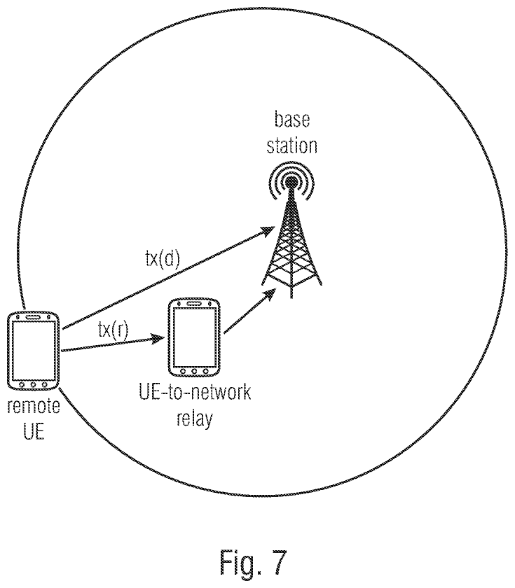

FIG. 7 shows a schematic view of a remote UE communicating over a UE-to-Network relay with a base station of the communication system. As indicated in FIG. 7, a transmit power tx(r) can be reduced when communicating via the UE-to-Network relay compared to the transmit power tx(d) when directly communicating with the base station. In other words, FIG. 7 shows a reduced tx power using relay-based communication (Geo-location based relay selection (relay assitance)).

In some specific geographic zones (regions), a sidelink communication can take place through a relay to enhance reliability. The reason can be for example bad channel condition, high reliability requirements, etc. The geo-location based relay (UE-to-UE or UE-to-Network) can be:
Pre-configured: like a RSU or a vehicular UE (or VUEs) in a specific zone such as a crossway, etc. The geographical areas (zones) may be (pre-) configured by gNB or RSU or a group (cluster) head in case of groupcast.
Ad hoc:
   A relay node may be selected ad-hoc by UEs in some geographic zones.
   A UE acts as a relay itself for other UEs when it enters some geographical location. For example, a UE may aggregate its broadcast or groupcast messages with the received broadcast and groupcast messages and transmit them to increase the reliability of such message by duplication.

### 6. Further Embodiments

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

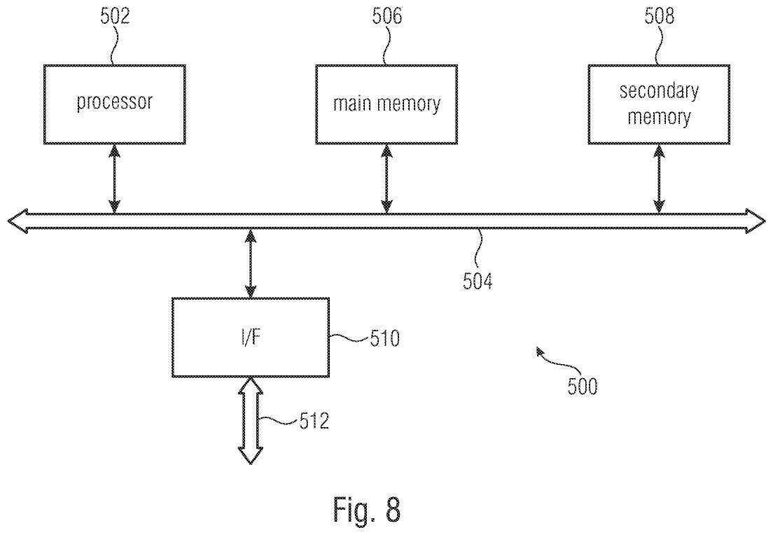

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 8 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] TS 23.303 “Proximity-based services (ProSe)”
[2] TR 36.746 Study on further enhancements to LTE Device to Device (D2D), User

Equipment (UE) to network relays for Internet of Things (loT) and wearables; (Release 15)
[3] TS 23.287 Architecture enhancements for 5G System (5GS) to support Vehicle-to-Everything (V2X) services; (Release 16)
[4] TR 23.752 Study on system enhancement for Proximity based Services (ProSe) in the 5G System (5GS); (Release 17)
[5] RP-192753—Summary of email discussion on Rel-17 Sidelink Relaying.
[6] 3GPP TS 23.733, “Study on architecture enhancements to Proximity Services (ProSe) UE-to-Network relay (Release-15)”

### ABBREVIATIONS

MCR minimum communication range
NR new radio
LTE long term evolution
UMTS universal mobile telecommunication system
UE user equipment
BS base station
NB node B
D2D device-to-device
V2V vehicle-to-vehicle
V2X vehicle-to-everything
IoT Internet of things
PDSCH physical downlink shared channel
PDCCH physical downlink control channel
PUSCH physical uplink shared channel
PUCCH physical uplink control channel
PSSCH physical sidelink shared channel
PSCCH physical sidelink control channel
PBCH physical broadcast channel
PRACH physical random access channel
DCI downlink control information
SCI sidelink control information
UCI uplink control information
SIB system information block
MIB master information block
TTI transmission time interval
SL sidelink
RAN radio access networks
RS reference symbols/signal
OFDM orthogonal frequency-division multiplexing
TDD time division duplex

1. Transceiver of a wireless communication system,
wherein the transceiver is configured to operate in a sidelink in-coverage, out of coverage or partial coverage scenario,
wherein the transceiver is configured to relay, in response to a reception of a sidelink relaying request and if one or more relaying criterions are fulfilled or pre-configured, signals in at least one direction between a remote transceiver and another transceiver of the wireless communication system,
wherein the transceiver is configured to transmit an information element indicating that the transceiver is configured to act as relay.

2. Transceiver according to claim 1,
wherein the transceiver is configured to receive the sidelink relaying request from remote transceiver.

3. Transceiver according to claim 1,
wherein the transceiver is configured to receive a relaying configuration to be used for relaying signals from a base station of the wireless communication network,
and/or wherein the transceiver is configured to determine at least some parameters of a relaying configuration used for relaying signals autonomously.

4. Transceiver according to claim 1,
wherein the transceiver is configured to operate, in response to receiving the sidelink relaying request from the remote transceiver and if the relaying criterion is fulfilled, in a relaying mode of operation in which the transceiver relays the signals in the at least one direction between the remote transceiver and the other transceiver.

5. Transceiver according to claim 1,
wherein a relaying criterion of the one or more relaying criterions indicates that the transceiver is selected by the remote transceiver as relaying transceiver.

6. Transceiver according to claim 1,
wherein a relaying criterion of the one or more relaying criterions indicates that at least one out of
a load of the traffic in the transceiver fulfills a requirement,
a remaining battery level of the transceiver fulfills a requirement,
a measured CR and/or CBR in the transceiver fulfills a requirement,
the transceiver is able to fulfill a QoS requirement of the remote transceiver,
a probability or risk that a transceiver may experience poor channel condition or poor coverage condition or may move into an out of coverage area.

7. Transceiver according to claim 1,
wherein the sidelink relaying request is initiated by
the remote transceiver,
the other transceiver,
a road side unit, RSU, of the wireless communication system,
a base station of the wireless communication system, or
a group or cluster head or any UE group member of the wireless communication system.

8. Transceiver according to claim 7,
wherein the sidelink relaying request is transmitted through
an information element over PC5,
a unicast link establishment message,
a discovery procedure of UEs,
an information element, IE, over Uu,
a direct link establishment,
an indication or a flag or one or several bits in the 1st or 2nd stage of SCI, or
an indication or a flag or one or several bits in the DCI,
a radio resource control, RRC, message,
piggy-backed on another type of message.

9. Transceiver according to claim 1,
wherein the transceiver is configured to, in case that HARQ based communication is performed between the remote transceiver and the other transceiver, take over buffering of messages, sending feedback to the transceiver out of the remote transceiver and the other transceiver that is the HARQ source and retransmission of messages to the transceiver out of the remote transceiver and the other transceiver that is the HARQ destination.

10. Transceiver of a wireless communication system,
wherein the transceiver is configured to operate in a sidelink in-coverage, out of coverage or partial coverage scenario,
wherein the transceiver is configured to select, in dependence on one or more selection criterions, a relaying transceiver of the wireless communication system for relaying signals in at least one direction between the transceiver and another transceiver of the wireless communication system,
wherein the transceiver is configured to communicate with the other transceiver by transmitting and/or receiving signals that are relayed by the selected relaying transceiver,
wherein the transceiver is configured to transmit a sidelink relaying request to at least one candidate relaying transceiver of the wireless communication system,
wherein the transceiver is configured to select a candidate relaying transceiver out of the at least one candidate relaying transceiver in dependence on the one or more selection criterions, to acquire the selected relaying transceiver,
wherein a selection criterion of the one or more selection criterions is a PC5 link quality of the respective candidate relaying transceiver,
wherein the PC5 link quality is based on one out of the following measurements:
a received signal strength of a discovery message.

11. Transceiver according to claim 10,
wherein a selection criterion of the one or more selection criterions indicates that the selected relaying transceiver is an active relaying transceiver that relayed a signal from the other transceiver to the transceiver,
or wherein a selection criterion of the one or more selection criterions indicates that a relaying response signal received from the selected relaying transceiver comprises the signal strength or a signal strength above a predefined threshold,
or wherein a selection criterion of the one or more selection criterions indicates that a QoS offered by the selected relaying transceiver fulfills a requested QoS requested by the transceiver.

12. Transceiver according to claim 10,
wherein the transceiver is configured to transmit the sidelink relaying request to only those candidate relaying transceivers that comprise
a defined or (pre-)configured signal strength, or
the best signal strength, or
a signal strength above a predefined threshold.

13. Transceiver according to claim 1,
wherein the transceiver is configured, if one or more reselection conditions are fulfilled, to reselect a relaying transceiver of the wireless communication system for relaying signals in at least one direction between the transceiver and another transceiver of the wireless communication system in dependence on one or more selection or reselection criterions.

14. Transceiver of a wireless communication system,
wherein the transceiver is configured to operate in a sidelink in-coverage, out of coverage or partial coverage scenario,
wherein the transceiver is configured to select, in dependence on one or more selection criterions, a relaying transceiver of the wireless communication system for relaying signals in at least one direction between the transceiver and another transceiver of the wireless communication system,
wherein the transceiver is configured to communicate with the other transceiver by transmitting and/or receiving signals that are relayed by the selected relaying transceiver,
wherein the transceiver is configured, if one or more reselection conditions are fulfilled, to reselect a relaying transceiver of the wireless communication system for relaying signals in at least one direction between the transceiver and another transceiver of the wireless communication system in dependence on one or more selection or reselection criterions,
wherein a reselection condition of the one or more reselection conditions is fulfilled when a reselection request from a higher layer of the transceiver or relaying transceiver is received.

15. Transceiver of a wireless communication system,
wherein the transceiver is configured to operate in a sidelink in-coverage, out of coverage or partial coverage scenario,
wherein the transceiver is configured to select, in dependence on one or more selection criterions, a relaying transceiver of the wireless communication system for relaying signals in at least one direction between the transceiver and another transceiver of the wireless communication system,
wherein the transceiver is configured to communicate with the other transceiver by transmitting and/or receiving signals that are relayed by the selected relaying transceiver,
wherein the transceiver is configured, if one or more reselection conditions are fulfilled, to reselect a relaying transceiver of the wireless communication system for relaying signals in at least one direction between the transceiver and another transceiver of the wireless communication system in dependence on one or more selection or reselection criterions,
wherein a reselection condition of the one or more reselection conditions is fulfilled when one out of
a PC5 link quality of the currently selected relaying transceiver is degraded,
a Uu link quality of the currently selected relaying transceiver is degraded,
a load of the currently selected relaying transceiver changes,
a number of negative HARQ feedbacks of the currently selected relaying transceiver increases,
a number of positive HARQ feedbacks of the currently selected relaying transceiver decreases,
a radio link failure occurs,
wherein thresholds of the one or more reselection conditions and/or their hysteresis are provided to the transceiver by pre-configuration.

16. Method for operating a transceiver of a wireless communication system, the method comprising:
operating the transceiver in a sidelink in-coverage, out of coverage or partial coverage scenario,
relaying, in response to a reception of a sidelink relaying request and if one or more relaying criterions are fulfilled or pre-configured, signals in at least one direction between a remote transceiver and another transceiver of the wireless communication system,
transmitting an information element indicating that the transceiver is configured to act as relay.

17. Method for operating a transceiver of a wireless communication system,
operating the transceiver in a sidelink in-coverage, out of coverage or partial coverage scenario, in which resources for a sidelink communication are pre-configured by the wireless communication system or allocated or scheduled autonomously by the transceiver,
selecting, in dependence on one or more selection criterions, a relaying transceiver of the wireless communication system for relaying signals in at least one direction between the transceiver and another transceiver of the wireless communication system,
communicating with the other transceiver by transmitting and/or receiving the signals that are relayed by the selected relaying transceiver,
transmitting a sidelink relaying request to at least one candidate relaying transceiver of the wireless communication system,
selecting a candidate relaying transceiver out of the at least one candidate relaying transceiver in dependence on the one or more selection criterions, to acquire the selected relaying transceiver,
wherein a selection criterion of the one or more selection criterions is a PC5 link quality of the respective candidate relaying transceiver,
wherein the PC5 link quality is based on one out of the following measurements:
a received signal strength of a discovery message.

18. Method for operating a transceiver of a wireless communication system,
operating the transceiver in a sidelink in-coverage, out of coverage or partial coverage scenario, in which resources for a sidelink communication are pre-configured by the wireless communication system or allocated or scheduled autonomously by the transceiver,
selecting, in dependence on one or more selection criterions, a relaying transceiver of the wireless communication system for relaying signals in at least one direction between the transceiver and another transceiver of the wireless communication system,
communicating with the other transceiver by transmitting and/or receiving the signals that are relayed by the selected relaying transceiver,
reselect, if one or more reselection conditions are fulfilled, a relaying transceiver of the wireless communication system for relaying signals in at least one direction between the transceiver and another transceiver of the wireless communication system in dependence on one or more selection or reselection criterions,
wherein a reselection condition of the one or more reselection conditions is fulfilled when a reselection request from a higher layer of the transceiver or relaying transceiver is received.

19. Method for operating a transceiver of a wireless communication system,
operating the transceiver in a sidelink in-coverage, out of coverage or partial coverage scenario, in which resources for a sidelink communication are pre-configured by the wireless communication system or allocated or scheduled autonomously by the transceiver,
selecting, in dependence on one or more selection criterions, a relaying transceiver of the wireless communication system for relaying signals in at least one direction between the transceiver and another transceiver of the wireless communication system,
communicating with the other transceiver by transmitting and/or receiving the signals that are relayed by the selected relaying transceiver,
reselecting, if one or more reselection conditions are fulfilled, a relaying transceiver of the wireless communication system for relaying signals in at least one direction between the transceiver and another transceiver of the wireless communication system in dependence on one or more selection or reselection criterions,
wherein a reselection condition of the one or more reselection conditions is fulfilled when one out of
a PC5 link quality of the currently selected relaying transceiver is degraded,
a Uu link quality of the currently selected relaying transceiver is degraded,
a load of the currently selected relaying transceiver changes,
a number of negative HARQ feedbacks of the currently selected relaying transceiver increases,
a number of positive HARQ feedbacks of the currently selected relaying transceiver decreases,
a radio link failure occurs,
wherein thresholds of the one or more reselection conditions and/or their hysteresis are provided to the transceiver by pre-configuration.

20. A non-transitory digital storage medium having a computer program stored thereon to perform the method for operating a transceiver of a wireless communication system, the method comprising:
operating the transceiver in a sidelink in-coverage, out of coverage or partial coverage scenario,
relaying, in response to a reception of a sidelink relaying request and if one or more relaying criterions are fulfilled or pre-configured, signals in at least one direction between a remote transceiver and another transceiver of the wireless communication system,
transmitting an information element indicating that the transceiver is configured to act as relay,
when said computer program is run by a computer.
